(19) United States
(12) Patent Application Publication
(10) Pub. No.: US 2026/0017892 A1
(43) Pub. Date: Jan. 15, 2026

(54) Artificial Intelligence Based Content Immersion Environment Generation

(71) Applicant: Disney Enterprises, Inc., Burbank, CA (US)

(72) Inventors: Dana Spillinger, Burbank, CA (US); Snehal Chitalia, Burbank, CA (US); Evan R. Golden, Burbank, CA (US); Alexandra Hernandez, Burbank, CA (US); Ricardo A. Melgoza, Burbank, CA (US)

(21) Appl. No.: 18/768,487

(22) Filed: Jul. 10, 2024

(51) Int. Cl. G06T 19/00; G06T 5/77

(52) U.S. Cl. CPC G06T 19/00; G06T 5/77

(57) ABSTRACT

A system includes a hardware processor and a memory storing an artificial intelligence based (AI-based) content immersion environment generator. The hardware processor executes the AI-based content immersion environment generator to receive media content including multiple video frames, identify one or more video frames for use in generating a content immersion environment for display of the media content, and analyze features of each of the one or more video frames to provide one or more respective depth maps. The hardware processor further executes the AI-based content immersion environment generator to generate, based on the one or more video frames and using a trained AI model and the one or more respective depth maps, a three-dimensional (3-D) content immersion environment corresponding respectively to each of the one or more identified video frames to provide one or more 3-D content immersion environments for the display of the media content.

### BACKGROUND

When a media consumer watches two-dimensional (2-D) video content such as a movie or television episode within an immersive virtual reality headset, the consumer sees the frame of that content and the three-dimensional (3-D) environment that fills up the space around the frame. That surrounding 3-D environment, which may take the form of a 3-D background including 3-D geometry and texture maps, can be important to achieving an immersive experience for the media consumer viewing the 2-D video content. However, conventional approaches to creating such 3-D environments typically require an artist to manually produce 3-D geometry models and texture maps on a title-by-title basis in a time consuming and costly process. As a result, the conventional process for producing 3-D backgrounds that are specific to and designed to enhance individual 2-D video content titles is undesirably expensive and inefficient, and may even be impractical for a large catalog of video content. Consequently, there is a need in the art for an efficient and cost effective solution for creating 3-D background environments that surround 2-D video frames with thematically appropriate images.

### BRIEF DESCRIPTION OF THE DRAWINGS

FIG. 1 shows a diagram of an exemplary system for performing artificial intelligence based (AI-based) content immersion environment generation, according to one implementation;

FIG. 2 shows a diagram depicting another exemplary system for performing AI-based content immersion environment generation, according to one implementation;

FIG. 3 shows an exemplary user system for consuming content embedded within an AI-based content immersion environment, according to one implementation;

FIG. 4 shows a frame of video content and a three-dimensional (3-D) content immersion environment generated for the video content, according to one implementation;

FIG. 5 shows a diagram of an exemplary AI-based content immersion environment generator suitable for use by the exemplary systems in FIGS. 1 and 2, according to one implementation; and

FIG. 6 shows a flowchart presenting a method for performing AI-based content immersion environment generation, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing artificial intelligence based (hereinafter “AI-based”) content immersion environment generation that address and overcome the deficiencies in the conventional art. As noted above, conventional approaches to creating three-dimensional (3-D) environments for two-dimensional (2-D) video content typically require an artist to manually produce 3-D geometry models and texture maps on a title-by-title basis in a time consuming and costly process. As a result, the conventional process for producing 3-D backgrounds that are specific to and designed to enhance individual 2-D video content titles is undesirably expensive and inefficient, and may even be impractical for a large catalog of video content. The present application discloses an efficient and cost effective solution for creating 3-D immersion environments that surround 2-D video frames with thematically appropriate images. Moreover, the present solution can advantageously be implemented as automated systems and methods.

As used in the present application, the terms “automation,” “automated” and “automating” refer to systems and processes that do not require the participation of a human artist, editor, or other system operator. Although in some implementations, a human operator may review the performance of the systems and methods disclosed herein, that human involvement is optional. Thus, the methods described in the present application may be performed under the control of hardware processing components of the disclosed automated systems.

The AI-based content immersion environment generation solution disclosed in the present application can advantageously be applied using a wide variety of different types of media content that includes video. Examples of such media content may include television (TV) episodes, movies, or video games, to name a few. In addition, or alternatively, in some implementations, such media content may be or include digital representations of persons, fictional characters, locations, objects, and identifiers such as brands and logos, for example, which populate a virtual reality (VR), augmented reality (AR), or mixed reality (MR) environment. That media content may depict virtual worlds that can be experienced by any number of users synchronously and persistently, while providing continuity of data such as personal identity, user history, entitlements, possessions, payments, and the like. Moreover, in some implementations, such media content may be or include digital content that is a hybrid of traditional audio-video and fully immersive VR/AR/MR experiences, such as interactive video.

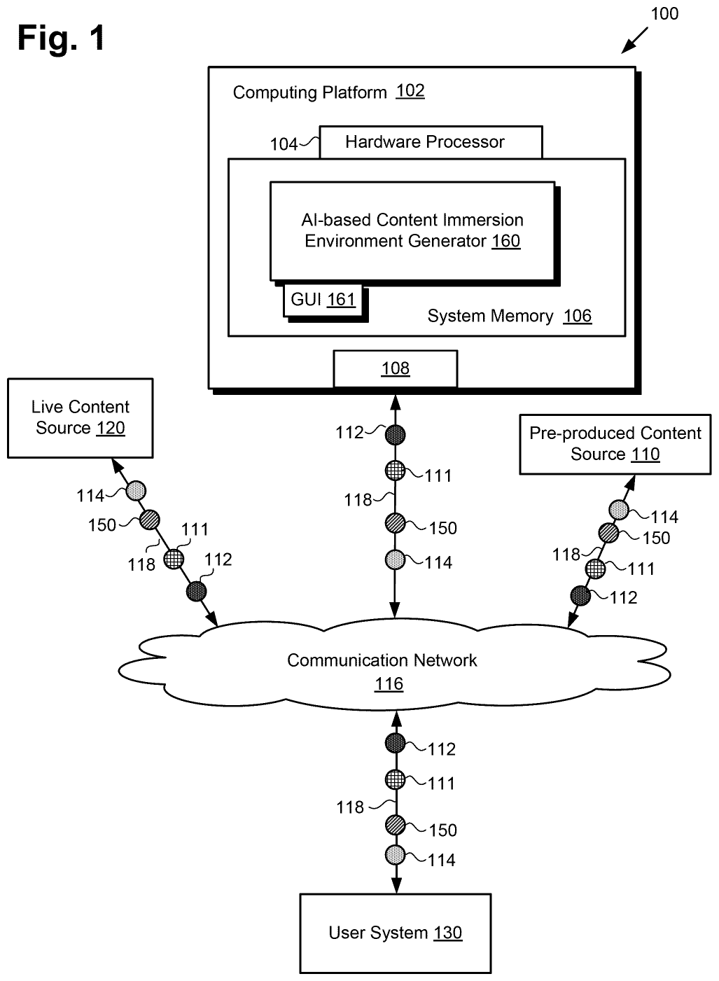

FIG. 1 shows a diagram of exemplary system 100 for performing AI-based content immersion environment generation, according to one implementation. System 100 includes computing platform 102 having hardware processor 104, system memory 106 implemented as a computer-readable non-transitory storage medium, and transceiver 108. According to the present exemplary implementation, system memory 106 stores AI-based content immersion environment generator 160 in the form of a machine learning (ML) model-based content immersion environment generator that may include multiple pre-trained off-the-shelf ML models and is configured to provide graphical user interface 161 (hereinafter “GUI 161”). For example, AI-based content immersion generator 160 may include one or more of a YOLOv8 model for performing image classification and segmentation, and SD-XL Inpainting 0.1 text-to-image diffusion model capable of generating photo-realistic images given any text input, with the extra capability of inpainting the pictures by using a mask, a ZoeD-M12NK: Zero-shot transfer model for generating depth maps, and a TripoSR model for fast feed-forward 3D reconstruction from a single image, to name a few.

It is noted that, as defined in the present application, the expression “ML model” refers to a computational model for making predictions based on patterns learned from samples of data or training data. Various learning algorithms can be used to map correlations between input data and output data. These correlations form the computational model that can be used to make future predictions on new input data. Such a predictive model may include one or more logistic regression models, Bayesian models, artificial neural networks (NNs) such as Transformers, large-language models, or multimodal foundation models, to name a few examples. In various implementations, ML models may be trained as classifiers and may be utilized to perform image processing, audio processing, natural-language processing, and other inferential analyses.

As shown in FIG. 1, system 100 is implemented within a use environment including one or more of pre-produced content source 110, live content source 120 and user system 130 any of which may provide media content 112 including video to system 100. System 100 may also receive data or instructions 111 (hereinafter “data/instructions 111”) from pre-produced content source 110, live content source 120, or user system 130, and may provide one or more 3-D content immersion environments 150 (hereinafter “3-D content immersion environment(s) 150”) or enhanced media content 114 as an output or outputs. Moreover, and as depicted in FIG. 1, in some use cases, one or both of pre-produced content source 110 and live content source 120 and may find it advantageous or desirable to make enhanced media content 114 available to user system 130 via communication network 116, which may take the form of a packet-switched network, such as the Internet. For instance, system 100 may be utilized by one or both of pre-produced content source 110 and live content source 120 to distribute enhanced media content 114 as part of a content stream, which may be an Internet Protocol (IP) content stream provided by a streaming service or a video-on-demand (VOD) service. Also shown in FIG. 1 are network communication links 118 of communication network 116 interactively connecting system 100 with one or more of pre-produced content source 110, live content source 120 and user system 130.

With respect to the representation of system 100 shown in FIG. 1, it is noted that although the present application refers to AI-based content immersion environment generator 160 as being stored in system memory 106 for conceptual clarity, more generally, system memory 106 may take the form of any computer-readable non-transitory storage medium.

The expression “computer-readable non-transitory storage medium,” as used in the present application, refers to any medium, excluding a carrier wave or other transitory signal that provides instructions to hardware processor 104 of computing platform 102 or to a hardware processor of user system 130. Thus, a computer-readable non-transitory storage medium may correspond to various types of media, such as volatile media and non-volatile media. Volatile media may include dynamic memory, such as dynamic random access memory (dynamic RAM), while non-volatile memory may include optical, magnetic, or electrostatic storage devices. Common forms of computer-readable non-transitory storage media include: optical discs such as DVDs, RAM, programmable read-only memory (PROM), erasable PROM (EPROM), and FLASH memory.

Moreover, in some implementations, system 100 may utilize a decentralized secure digital ledger in addition to, or in place of, system memory 106. Examples of such decentralized secure digital ledgers may include a blockchain, hashgraph, directed acyclic graph (DAG), and Holochain® ledger. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Although FIG. 1 depicts AI-based content immersion environment generator 160 as being stored in its entirety in system memory 106, that representation is also provided merely as an aid to conceptual clarity. More generally, system 100 may include one or more computing platforms 102, such as computer servers, which may be co-located, or may form an interactively linked but distributed system, such as a cloud-based system. As a result, hardware processor 104 and system memory 106 may correspond to distributed processor and memory resources within system 100. Consequently, in some implementations, various components of AI-based content immersion environment generator 160 may be stored remotely from one another on the distributed memory resources of system 100.

Hardware processor 104 may include multiple processing units, such as one or more central processing units, one or more graphics processing units and one or more tensor processing units, one or more field-programmable gate arrays (FPGAs), custom hardware for machine-learning training or inferencing, and an application programming interface (API) server. By way of definition, as used in the present application, the terms “central processing unit” (CPU), “graphics processing unit” (GPU), and “tensor processing unit” (TPU) have their customary meaning. That is to say, a CPU includes an Arithmetic Logic Unit (ALU) for carrying out the arithmetic and logical operations of computing platform 102, as well as a Control Unit (CU) for retrieving programs from system memory 106, while a GPU may be implemented to reduce the processing overhead of the CPU by performing computationally intensive graphics or other processing tasks. A TPU is an application-specific integrated circuit (ASIC) configured specifically for AI processes such as machine learning.

In some implementations, computing platform 102 may correspond to one or more web servers accessible over a packet-switched network such as the Internet. Alternatively, computing platform 102 may correspond to one or more computer servers supporting a wide area network (WAN), a local area network (LAN), or included in another type of private or limited distribution network. In addition, or alternatively, in some implementations system 100 may utilize a local area broadcast method, such as User Datagram Protocol (UDP) or Bluetooth®. For example, in some implementations, system 100 may be implemented in software, or as virtual machines. Moreover, in some implementations, system 100 may be configured to communicate via a high-speed network suitable for high performance computing (HPC). Thus, in some implementations, communication network 116 may be or include a 10 GigE network or an Infiniband network, for example.

Transceiver 108 of system 100 may be implemented as a wireless communication unit configured for use with one or more of a variety of wireless communication protocols. For example, transceiver 108 may include a fourth generation (4G) wireless transceiver, a 5G wireless transceiver, or both a 4G and a 5G wireless transceiver. In addition, or alternatively, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

User system 130 may take the form of any suitable mobile or stationary computing device or system that implements data processing capabilities sufficient to provide a user interface, support connections to communication network 116, and implement the functionality ascribed to user system 130 herein. In various implementations, user system 130 may take the form of a desktop computer, laptop computer, tablet computer, smartphone, smart television (smart TV), digital media player, game console, or a wearable communication device such as a smartwatch, AR device, or VR device (e.g., headset), to name a few examples. It is noted that in various use cases, user system 130 may be or include a work station of a creator or editor of media content 112, or may be or include an end-user device, such as a VR headset, utilized by an end-user consumer of enhanced media content 114.

In one implementation, pre-produced content source 110 may be a media entity providing media content 112. Media content 112 may include content from a linear TV program stream, including high-definition (HD) or ultra-HD (UHD) baseband video signal with embedded audio, captions, time code, and other ancillary metadata, such as ratings and parental guidelines. In some implementations, media content 112 may also include multiple audio tracks, and may utilize secondary audio programming (SAP), Descriptive Video Service (DVS) or SAP and DVS. Alternatively, in some implementations, media content 112 may be movie content, such as feature film content, or video game content. As noted above, in some implementations media content 112 may be enhanced by 3-D immersion environment(s) including digital representations of persons, fictional characters, locations, objects, and identifiers such as brands and logos, which populate a VR, AR, or MR environment, as described in greater detail below. As also noted above, in some implementations media content 112 may be enhanced by 3-D immersion environment(s) depicting virtual worlds that can be experienced by any number of users synchronously and persistently, while providing continuity of data such as personal identity, user history, entitlements, possessions, payments, and the like. Moreover, it is noted that the same media content 112 may be enhanced by multiple different 3-D immersion environments that may be transitioned through automatically based on scene changes or other narrow shifts within content 112.

In some implementations, media content 112 may be the same source video that is broadcast to a traditional TV audience. Thus, pre-produced content source 110, live content source 120, or both, may take the form of a conventional cable TV network or a satellite TV network, for example. In some use cases, pre-produced content source 110, live content source 120, or both, may find it advantageous or desirable to make one or more of media content 112, 3-D content immersion environment(s) 150, or enhanced media content 114 available via an alternative distribution channel, such as by being streamed via communication network 116 in the form of a packet-switched network, such as the Internet.

Alternatively, or in addition, although not depicted in FIG. 1, in some use cases one or more of media content 112, 3-D content immersion environment(s) 150, or enhanced media content 114 may be distributed on a physical medium, such as a DVD, Blu-ray Disc®, or FLASH drive.

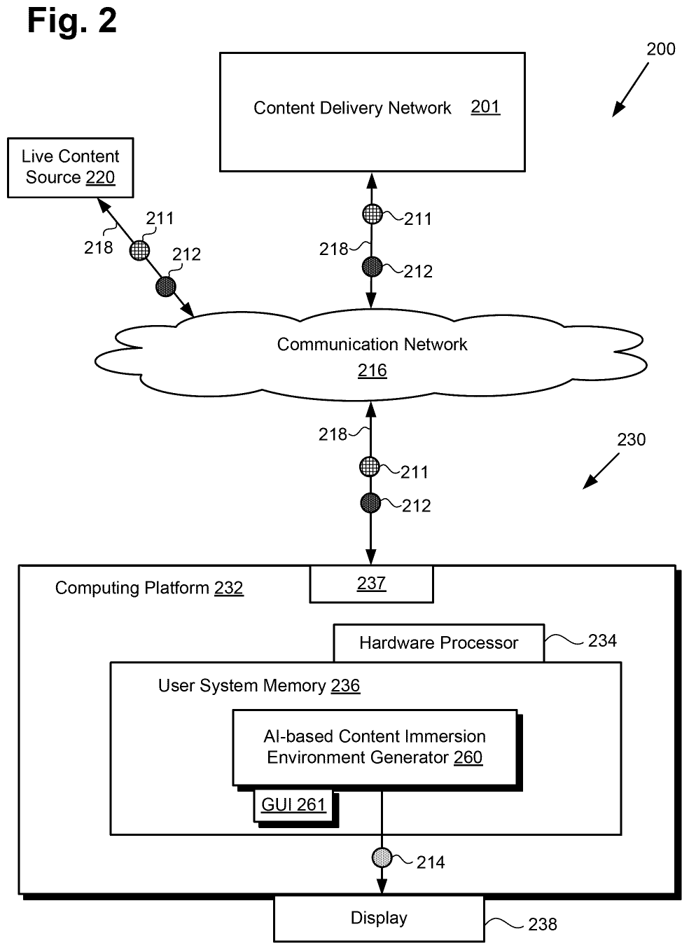

FIG. 2 shows another exemplary system, i.e., user system 230, for performing AI-based content immersion environment generation, according to one implementation. As shown in FIG. 2, user system 230 includes computing platform 232 having hardware processor 234, transceiver 237, display 238 and user system memory 236 implemented as a computer-readable non-transitory storage medium storing AI-based content immersion environment generator 260, which may include graphical user interface 261 (hereinafter “GUI 261”).

As further shown in FIG. 2, user system 230 is utilized in use environment 200 including live content source 220 and content delivery network 201 (hereinafter “CDN 201”). One or both of live content source 220 and CDN 201 distributes media content 212 to user system 230 via communication network 216 and network communication links 218. According to the implementation shown in FIG. 2, AI-based content immersion environment generator 260 stored in user system memory 236 of user system 230 is configured to receive media content 212 and to output enhanced media content 214 for rendering on display 238 of user system 230.

Live content source 220, media content 212, enhanced media content 214, communication network 216 and network communication links 218 correspond respectively in general to live content source 120, media content 112, enhanced media content 114, communication network 116 and network communication links 118, in FIG. 1. In other words, live content source 220, media content 212, enhanced media content 214, communication network 216 and network communication links 218 may share any of the characteristics attributed to respective live content source 120, media content 112, enhanced media content 114, communication network 116 and network communication links 118 by the present disclosure, and vice versa.

User system 230, in FIG. 2, corresponds in general to user system 130 in FIG. 1. Thus, user system 130 may share any of the characteristics attributed to user system 230 by the present disclosure, and vice versa. For example, although not shown in FIG. 1, user system 130 may include features corresponding respectively to computing platform 232, hardware processor 234, transceiver 237, display 238 and user system memory 236 storing AI-based content immersion environment generator 260 including GUI 261.

Hardware processor 234 may include a multiple hardware processing units, such as one or more CPUs, one or more GPUs, one or more TPUs, and one or more FPGAs, as those features are defined above. Display 238 of user system 130/230 may take the form of a liquid crystal display (LCD), light-emitting diode (LED) display, organic light-emitting diode (OLED) display, quantum dot (QD) display, or any other suitable display screen that performs a physical transformation of signals to light. Furthermore, display 238 may be physically integrated with user system 130/230 or may be communicatively coupled to but physically separate from user system 130/230. For example, where user system 130/230 is implemented as a smartphone, laptop computer, tablet computer, or VR headset, display 238 will typically be integrated with user system 130/230. By contrast, where user system 130/230 is implemented as a desktop computer, display 238 may take the form of a monitor separate from user system 130/230 in the form of a computer tower.

Transceiver 237 may be implemented as a wireless communication unit configured for use with one or more of a variety of wireless communication protocols. For example, transceiver 237 may include a 4G wireless transceiver, a 5G wireless transceiver, or both a 4G and 5G wireless transceiver. In addition, or alternatively, transceiver 237 may be configured for communications using one or more of Wi-Fi®, WiMAX®, Bluetooth®, BLE, ZigBee®, RFID, NFC, and 60 GHz wireless communications methods.

AI-based content immersion environment generator 260 and GUI 261, in FIG. 2, correspond respectively in general to AI-based content immersion environment generator 160 and GUI 161, in FIG. 1. Thus, AI-based content immersion environment generator 260 and GUI 261 may share any of the characteristics attributed to respective AI-based content immersion environment generator 160 and GUI 161 by the present disclosure, and vice versa. In other words, AI-based content immersion environment generator 260 may include all of the features and be capable of performing all of the operations attributed to AI-based content immersion environment generator 160 by the present disclosure. In other words, in implementations in which hardware processor 234 of user system 130/230 executes AI-based content immersion environment generator 260 stored locally in user system memory 236, user system 130/230 may perform any of the actions attributed to system 100 by the present disclosure. Thus, in some implementations, AI-based content immersion environment generator 260 executed by hardware processor 234 of user system 130/230 may receive media content 212 and may output enhanced media content 214 for rendering on display 238 of user system 230.

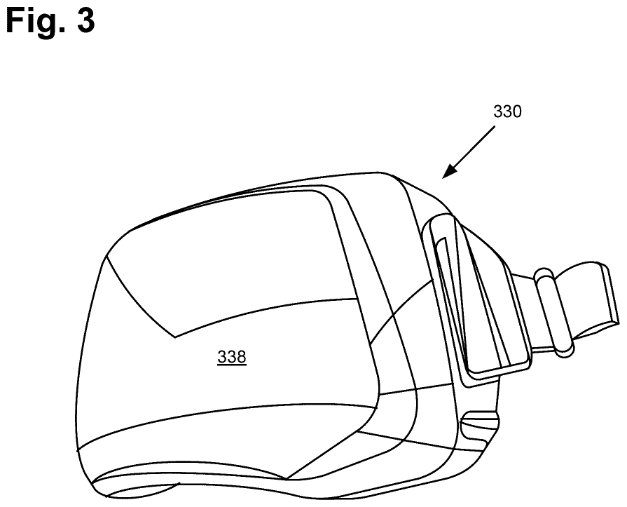

FIG. 3 shows exemplary user system 330 for consuming content embedded within an AI-based content immersion environment, according to one implementation. As shown in FIG. 3, user system 330 may take the form of a wearable VR viewing device, such as a VR headset for example, including internal display screen 338 (hereinafter “display 338”). User system 330 corresponds in general to user system 130/230 in FIGS. 1 and 2. Thus, user system 330 may share any of the characteristics attributed to user system 130/230 by the present disclosure, and vice versa. For example, although not shown in FIG. 3, user system 330 may include features corresponding respectively to computing platform 232, hardware processor 234, transceiver 237 and user system memory 236 storing AI-based content immersion environment generator 160/260. Moreover, like display 238, display 338 may take the form of an LCD, LED display, OLED display, QD display, or any other suitable display screen that performs a physical transformation of signals to light.

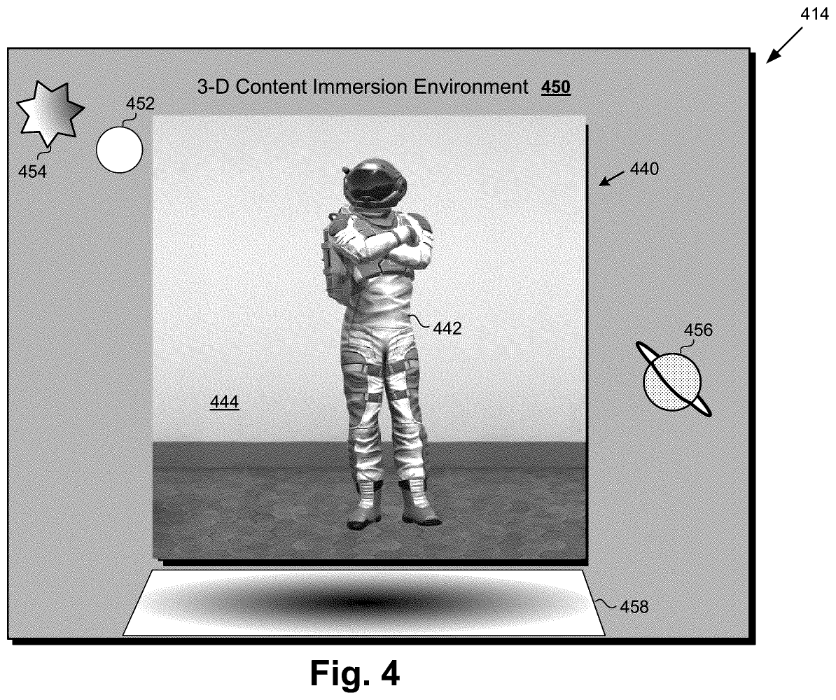

FIG. 4 shows enhanced media content 414 including 2-D video frame 440 surrounded by exemplary 3-D content immersion environment 450 generated for media content that includes 2-D video frame 440, according to one implementation. It is noted that 2-D video frame 440 may be one of a sequence of multiple video frames included in media content 112/212 in FIGS. 1 and 2. It is further noted that, in some implementations, 3-D content immersion environment 450 may be provided as an open Universal Scene Description (USD) file, or any other static image file representing a 3-D environment. 3-D content immersion environment 450 corresponds in general to any one of 3-D content immersion environment(s) 150, in FIG. 1. As a result, 3-D content immersion environment(s) 150 may share any of the characteristics attributed to 3-D content immersion environment 450 by the present disclosure, and vice versa. Moreover, enhanced media content 414 corresponds in general to enhanced media content 114/214 in FIGS. 1 and 2. Consequently, enhanced media content 114/214 may share any of the characteristics attributed to enhanced media content 414 by the present disclosure, and vice versa.

As shown in FIG. 4, 2-D video frame 440 of enhanced media content 414 depicts astronaut 442 on barren planetary landscape 444. As further shown in FIG. 4, 2-D video frame 440 is surrounded by 3-D content immersion environment 450 of enhanced media content 414 displaying 3-D visual features including star 454 partially eclipsed by moon 452, ringed planet 456 and quicksand marsh 458 thematically related to the content of 2-D video frame 440.

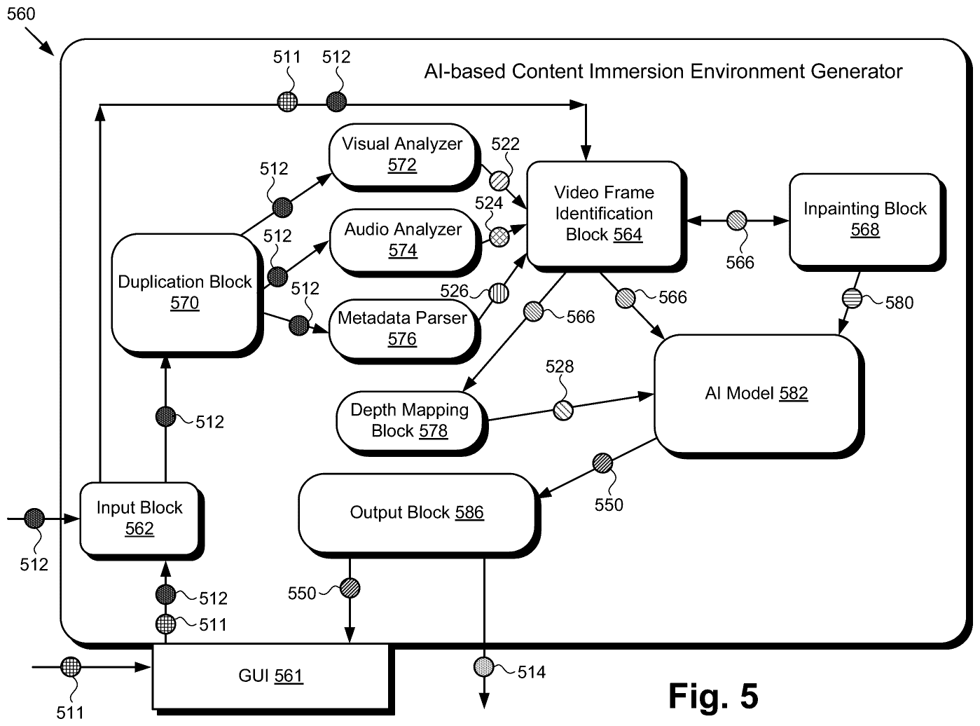

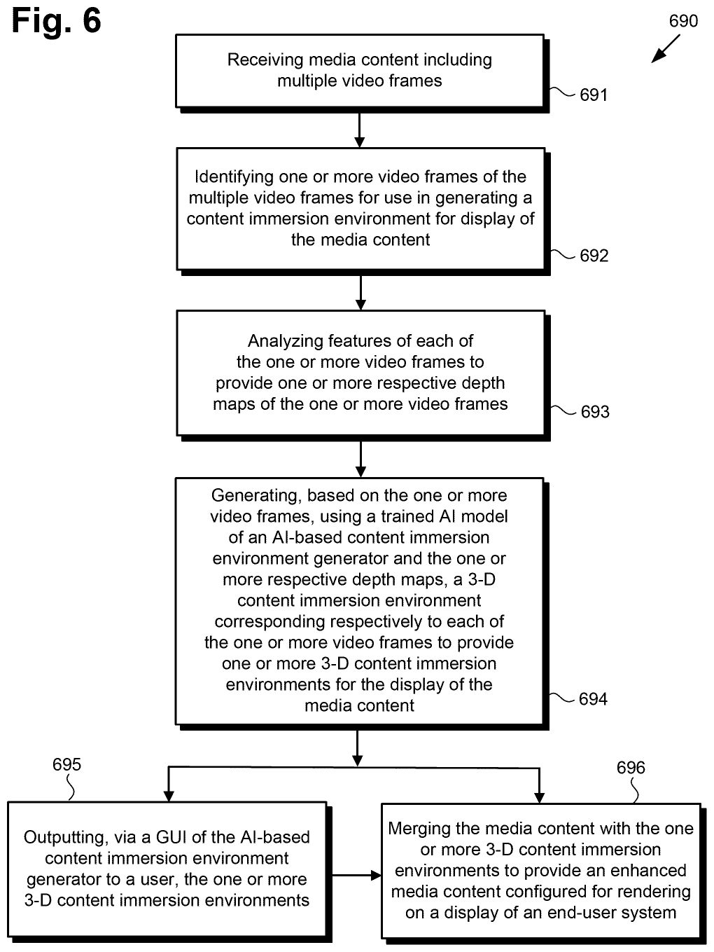

The functionality of system 100, user system 130/230/330, and AI-based content immersion environment generator 160/260 shown variously in FIGS. 1, 2, and 3 will be further described by reference to FIGS. 5 and 6. FIG. 5 shows a diagram of exemplary AI-based content immersion environment generator 560 suitable for use by exemplary system 100 or user system 130/230/330, according to one implementation, while FIG. 6 shows flowchart 690 presenting an exemplary method for performing AI-based content immersion environment generation. With respect to the method outlined in FIG. 6, it is noted that certain details and features have been left out of flowchart 690 in order not to obscure the discussion of the inventive features in the present application.

Referring to FIG. 5, AI-based content immersion environment generator 560 may include graphical user interface 561 (hereinafter “GUI 561”) and one or more of input block 562, duplication block 570, visual analyzer 572, audio analyzer 574, metadata parser 576, depth mapping block 578, video frame identification block 564, inpainting block 568, AI model 582, and output block 586. It is noted that AI model 582 may be a generative AI model specifically trained to generate a content immersion environment for media content 512. In addition to the features identified above, FIG. 5 also shows media content 512, data or instructions 511 (hereinafter “data/instructions 511”), visual analysis data 522, audio analysis data 524, content metadata 526, one or more depth maps 528 (hereinafter “depth map(s) 528”), one or more video frames 566 (hereinafter “video frame(s) 566”) for use in generating a content immersion environment for media content 512, one or more inpainted video frames 580 (hereinafter “inpainted video frame(s) 580”), one or more 3-D content immersion environments 550 (hereinafter “3-D content immersion environment(s) 550”) and enhanced media content 514.

Media content 512, data/instructions 511, enhanced media content 514 and 3-D content immersion environment(s) 550 correspond respectively in general to media content 112/212, data/instructions 111, enhanced media content 114/214/414 and 3-D content immersion environment(s) 150/450 shown variously in FIGS. 1, 2 and 4. Consequently, media content 512, data/instructions 511, enhanced media content 514 and 3-D content immersion environment(s) 550 may share any of the characteristics attributed to respective media content 112/212, data/instructions 111, enhanced media content 114/214/414 and 3-D content immersion environment(s) 150/450 by the present disclosure, and vice versa.

In addition, AI-based content immersion environment generator 560 and GUI 561 correspond respectively in general to AI-based content immersion environment generator 160/260 and GUI 161/261, in FIGS. 1 and 2. Thus, AI-based content immersion environment generator 160/260 and GUI 161/261 may share any of the characteristics attributed to AI-based content immersion environment generator 560 and GUI 561 by the present disclosure, and vice versa. For example, like AI-based content immersion environment generator 560, AI-based content immersion environment generator 160/260 may include features corresponding respectively to input block 562, duplication block 570, visual analyzer 572, audio analyzer 574, metadata parser 576, depth mapping block 578, video frame identification block 564, inpainting block 568, trained AI model 582, and output block 586.

Referring to FIG. 6 in combination with FIGS. 1, 2, 4 and 5, the method outlined by flowchart 690 includes receiving media content 112/212/512, media content 112/212/512 including multiple video frames, such as video frame 440 for example (action 691). Media content 112/212/512 may include content in the form of video games, music videos, animation, movies, or episodic TV content that includes episodes of TV shows that are broadcasted, streamed, or otherwise available for download or purchase on the Internet or via a user application. In addition, or alternatively, as noted above in some implementations media content 112/212/512 may be or include digital representations of persons, fictional characters, locations, objects, and identifiers such as brands and logos, which populate a VR, AR, or MR environment. Moreover, and as further noted above, in some implementations, media content 112/212/512 may depict virtual worlds that can be experienced by any number of users synchronously and persistently, while providing continuity of data such as personal identity, user history, entitlements, possessions, payments, and the like. As also noted above, media content 112/212/512 may be or include content that is a hybrid of traditional audio-video and fully immersive VR/AR/MR experiences, such as interactive video.

In some implementations, media content 112/212/512 may be live content such, as a live transmission of a sporting event for example, received from live content source 120/220. Alternatively, media content 112/212/512 may be pre-produced content, received from pre-produced content source 110 or via CDN 201. Referring to FIGS. 1, 5 and 6 in combination, in some implementations, media content 112/512 may be received, in action 691, by input block 562 of AI-based content immersion environment generator 160/560 of system 100, executed by hardware processor 104 of computing platform 102. In other implementations, referring to FIGS. 2, 5 and 6 in combination, media content 112/512 may be received, in action 691, by input block 562 of AI-based content immersion environment generator 260/560 of user system 230, executed by hardware processor 234 of user system computing platform 232.

Referring to FIG. 6 in combination with FIGS. 1, 2, 4 and 5, the method outlined by flowchart 690 further includes identifying video frame(s) 566 of the multiple video frames included in media content 112/212/512, for use in generating a content immersion environment for display of media content 112/212/512 (action 692). In some use cases, identification of video frame(s) 566 may be based on data/instructions 111/511 received from a user of user system 130/230, who may be a creator or editor of media content 112/212/512, or may be an end-user of media content 112/212/512 such as a consumer of media content 112/212/512 for example.

As noted above, in some implementations AI-based content immersion environment generator 160/260/560 may include GUI 161/261/561. In those implementations, action 692 may include receiving, via GUI 161/261/561 from a user of user system 130/230, data/instructions 111/511 expressly identifying video frame(s) 566 or providing instructions for use in identifying video frame(s) 566. For example, in some implementations, data/instructions 111/511 may specify which video frame or frames included in media content 112/212/512 are to be used to generate the content immersion environment for display of media content 112/212/512.

Alternatively, or in addition, data/instructions 111/511 may command AI-based content immersion environment generator 160/260/560 to identify video frame(s) 566 in an automated process. For instance, data/instructions 111/511 may command use of every nth video frame, where “n” is any integer value, or may command identification of one or more video frames per shot or per scene of media content 112/212/512, either randomly or based on a selection criterion and metadata included with content 112/212/512, or may command identification of one or more video frames per specified timecode interval of media content 112/212/512, again either randomly or based on a selection criterion and metadata included with content 112/212/512. It is noted that, as defined in the present application, the term “shot,” as applied to video content refers to a sequence of frames of video that are captured from the perspective of an individual camera without cuts or other cinematic transitions. The term “scene,” refers to a shot or series of shots that together deliver a single, complete and unified dramatic element of movie, TV, or video game presentation, or block of action or storytelling within a movie, TV content, or video game.

Referring to FIGS. 5 and 6 in combination, in implementations in which action 692 is performed in an automated process, duplication block 570 of AI-based content immersion environment generator 560 may be used to produce multiple copies of media content 512, which may be analyzed in parallel using one or more of visual analyzer 572, audio analyzer 574 and metadata parser 576, for example. Thus, in some use cases, video frame(s) 566 may be identified using video frame identification block 564 of AI-based content immersion environment generator 560 based on visual analysis data 522 produced by visual analyzer 572, audio analysis data 524 produced by audio analyzer 524, content metadata 526 included with media content 512, or any combination thereof. It is noted that, in some implementations, video frame identification block 564 may include a pre-trained image classification and segmentation ML model, such as a YOLOv8 model, for example.

It is further noted that in addition to identifying video frame(s) 566, providing instructions for identifying video frame(s) 566 in an automated process, or both, one or both of data/instructions 511 and content metadata 526 may specify the types of transitions to occur between successive 3-D content immersion environment(s) 550 during the display of media content 512, such as cross-fades or screen wipes for example. It is also noted that one or both of visual analyzer 572 and audio analyzer 574 may be or include AI-based models. By way of example, visual analyzer 572 may take the form of an AI model configured to perform Computer Vision.

Referring to FIGS. 1, 5 and 6 in combination, in some implementations, action 692 may be performed by AI-based content immersion environment generator 160/560 of system 100, executed by hardware processor 104 of computing platform 102. In other implementations, referring to FIGS. 2, 5 and 6 in combination, action 692 may be performed by AI-based content immersion environment generator 260/560 of user system 230, executed by hardware processor 234 of user system computing platform 232.

Referring to FIGS. 5 and 6 in combination, the method outlined by flowchart 690 further includes analyzing features of video frame(s) 566 to provide respective depth map(s) 528 of video frame(s) 566 (action 693). For example, depth mapping block 578 of AI-based content immersion environment generator 560 may be used to analyze foreground, middle-ground and background features of video frame(s) 566 and to produce a 3-D depth map for each of video frame(s) 566. By way of example, depth mapping block 578 of AI-based content immersion environment generator 560 may be implemented so as to be or include a ZoeD-M12NK: Zero-shot transfer model.

Referring to FIGS. 1, 5 and 6 in combination, in some implementations, action 693 may be performed by AI-based content immersion environment generator 160/560 of system 100, executed by hardware processor 104 of computing platform 102. In other implementations, referring to FIGS. 2, 5 and 6 in combination, action 693 may be performed by AI-based content immersion environment generator 260/560 of user system 230, executed by hardware processor 234 of user system computing platform 232.

Referring to FIGS. 5 and 6 in combination, flowchart 690 further includes generating, based on video frame(s) 566, and using trained AI model 582 of AI-based content immersion environment generator 560 and respective depth map(s) 528, a 3-D content immersion environment corresponding respectively to each of video frame(s) 566 to provide 3-D content immersion environment(s) 550 for the display of media content 512 (action 694). In some implementations, as shown in FIG. 5, video frame(s) 566 and depth map(s) 528 may be provided as inputs to trained AI model 582 and may be used by trained AI model 582 to generate 3-D content immersion environment(s) 550. In some implementations, trained AI model 582 may be or include a TripoSR model for fast feed-forward 3D reconstruction from a single image, for example. Moreover, and as noted above, in some implementations 3-D content immersion environment 550 may be provided as an open USD file, or any other static image file representing a 3-D environment.

In some implementations, 3-D content immersion environment(s) 550 generated in action 694 may include only features included in media content 512. However, in other implementations, 3-D content immersion environment(s) 550 generated in action 694 may include features that are thematically related to media content 512 but not included in media content 512, based on metadata tags included with media content 512, the thematically related media content, or media content 512 and the thematically related content. For example, where media content 512 includes a particular movie from a movie franchise, 3-D content immersion environment(s) 550 may include features, such as objects or characters, depicted in one or more other movies from the same franchise. As another example, and referring further to FIGS. 2 and 3, where media content 512 is live content of a sporting event, 3-D content immersion environment(s) 550 may include features, based on stock photos, for example, input to system 230/330 by a user of system 230/330 and depicting the sporting venue, city, or geographical region where the sporting event is occurring. In addition, or alternatively, where a user of user system 230/330 is an end-user consumer of live media content 212/512 of a sporting event and is a fan of a particular sports team, team specific branding and logos for that team may be included among the features of 3-D content immersion environment(s) 550. These ancillary features drawn from content other than media content 212/512 may be included among or identified by data/instructions 511.

Referring once again to FIG. 5, although in some implementations 3-D content immersion environment(s) 550 generated in action 694 may include only static, i.e., non-moving features, in use cases in which media content 512 includes one or more features (hereinafter “interaction-suitable feature(s)”) lending itself or themselves to corresponding dynamic features, 3-D content immersion environment(s) 550 generated in action 694 may include one or more interactive features corresponding respectively to that/those interaction-suitable feature(s). By way of example, where media content 512 depicts a fireworks display, one or more of 3-D content immersion environment(s) 550 may include dynamic starbursts, shooting stars, or exploding fireworks. It is noted that in some implementations, the addition of the one or more interactive features, such as animations, may be performed manually by a user of system 230/330 in FIGS. 2 and 3, in post-processing of 3-D content immersion environment(s) 550.

In implementations in which 3-D content immersion environment(s) 550 can include interactive features, action 694 may further include identifying, using an AI-based visual analyzer of AI-based content immersion environment generator 560, such as visual analyzer 572 for example, one or more interaction-suitable features depicted in at least one of video frame(s) 566. In those implementations, the 3-D content immersion environment corresponding to that at least one of video frame(s) 566 including the interaction-suitable feature(s) and generated in action 694 may include at least one interactive environmental feature corresponding to at least one of the identified interaction-suitable feature(s).

It is noted that in some use cases it may be advantageous or desirable to prevent images of humans, humanoids, or animals depicted in media content 512 from being visible in 3-D content immersion environment(s) 550 for the display of media content 512. For example, in some use cases the presence of humans, humanoids, or animals in 3-D content immersion environment(s) 550 may be distracting, may tend to break the immersive experience, or both. In some of those use cases, action 694 may further include determining whether any of video frame(s) 566 contains an image segment depicting a human, humanoid, or animal, and inpainting the image segment, when it is determined that video frame(s) 566 contain such an image segment, thereby obscuring the human, humanoid, or animal to provide inpainted video frame(s) 580. In those implementations, generating a 3-D content immersion environment corresponding to each of inpainted video frame(s) 580 uses those respective inpainted video frame(s).

Alternatively, in some use cases, a user of system 230/330 may use GUI 261/561 to selectively prevent some but not all human, humanoid, or animal representations present in media content 512 from being visible in 3-D content immersion environment(s) 550 for the display of media content 512, based in the creative preferences of the user. As yet another alternative, all human, humanoid, or animal representations present in media content 512 may be prevented from being visible in 3-D content immersion environment(s) 550 for the display of media content 512 initially, and the user of system 230/330 may selectively reintroduce some human, humanoid, or animal images into 3-D content immersion environment(s) 550 during post-processing of 3-D content immersion environment(s) 550.

Referring to FIGS. 1, 5 and 6 in combination, in some implementations, action 694 may be performed by AI-based content immersion environment generator 160/560 of system 100, executed by hardware processor 104 of computing platform 102, and using trained AI model 582. In other implementations, referring to FIGS. 2, 5 and 6 in combination, action 694 may be performed by AI-based content immersion environment generator 260/560 of user system 230, executed by hardware processor 234 of user system computing platform 232, and using trained AI model 582.

Referring to FIGS. 1, 5 and 6 in combination, in some implementations, flowchart 690 may further include outputting, via GUI 161/561 to a user of user system 130, 3-D content immersion environment(s) 150/550 (action 695). It is noted that action 695 is optional, and in some implementations may be omitted from the method outlined by flowchart 690. In implementations in which action 695 is performed, 3-D content immersion environment(s) 150/550 may be output to the user of user system 130 for review, approval, rejection, or editing by the user, who may be a creator or editor of media content 112/512, or who may be one or more of a creator, editor and end-user consumer of enhanced media content 114/514. 3-D content immersion environment(s) 150/550 may be output to the user of user system 130 as part of an Open USD file viewable in a browser of user system 130, for example. Alternatively, or in addition, a quick-response (QR) code or Uniform Resource Identifier (URI) such as a Universal Resource Locator (URL) link to a preview file could be output to user system 130 when user system 130 is a mobile device or head mounted display.

In some implementations, and as shown by FIG. 1, 3-D content immersion environment(s) 150/550 may be output to pre-produced content source 110 or live content source 120 for review, approval, rejection, or editing. When included in the method outlined by flowchart 690, action 695 may be performed by AI-based content immersion environment generator 160/560 of system 100, executed by hardware processor 104 of computing platform 102, and using output block 586 and GUI 161/561.

Referring to FIGS. 1, 2, 3, 5 and 6 in combination, in some implementations, flowchart 690 may further include merging media content 112/212/512 with 3-D content immersion environment(s) 150/550 to provide enhanced media content 114/214/514 configured for rendering on a display of an end-user system, e.g., display 238/338 of user system 130/230/330 (action 696). It is noted that action 696 is optional, and in some implementations may be omitted from the method outlined by flowchart 690. Moreover, and as shown by FIGS. 1 and 2, in some implementations enhanced media content 114/214/514 may be provided to pre-produced content source 110 or live content source 120/220.

Referring to FIGS. 1, 5 and 6 in combination, in some implementations, enhanced media content 114/514 may be provided in optional action 696 via communication network 116 and network communication links 118 by AI-based content immersion environment generator 160/560 of system 100, executed by hardware processor 104 of computing platform 102, and using output block 586. In other implementations, referring to FIGS. 2, 3, 5 and 6 in combination, enhanced media content 214/514 may be provided in optional action 696 by being output to display 238/338 of user system 230/330 by AI-based content immersion environment generator 260/560 of user system 230/330, executed by hardware processor 234 of user system computing platform 232, and using output block 586. Furthermore, and as further shown by FIG. 3, in some implementations the end-user device to which enhanced media content 114/214/514 is provided may be a VR device such as a VR headset.

With respect to the method outlined by flowchart 690 and described above, it is noted that actions 691, 692, 693 and 694 (hereinafter “actions 691-694”) as well as optional action 695, or actions 691-694 and optional action 696, or actions 691-694 and optional actions 695 and 696, may be performed in an automated process from which human participation may be omitted.

Thus, the present application discloses systems and methods for performing AI-based content immersion environment generation that address and overcome the deficiencies in the conventional art. The AI-based content immersion environment generation systems and methods disclosed in the present application advance the state-of-the-art by providing an efficient and cost effective solution for creating 3-D immersion environments that surround 2-D video frames with thematically appropriate images, thereby enhancing the media content consumption experience of end-users.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory;
the system memory storing an artificial intelligence based (AI-based) content immersion environment generator;
the hardware processor configured to execute the AI-based content immersion environment generator to:
receive media content, the media content including a plurality of video frames;
identify one or more video frames of the plurality of video frames for use in generating a content immersion environment for a display of the media content;
analyze features of each of the one or more video frames to provide one or more respective depth maps of the one or more video frames; and
generate, based on the one or more video frames, using a trained AI model of the Al-based content immersion environment generator and the one or more respective depth maps, a three-dimensional (3-D) content immersion environment corresponding respectively to each of the one or more video frames to provide one or more 3-D content immersion environments for the display of the media content.

2. The system of claim 1, wherein the AI-based content immersion environment generator includes a graphical user interface (GUI), and wherein before identification of the one or more video frames is performed, the hardware processor is further configured to execute the AI-based content immersion environment generator to:
receive, via the GUI from a user of the system, data identifying the one or more video frames or one or more instructions for use when identifying the one or more video frames.

3. The system of claim 2, wherein the one or more instructions are received via the GUI, and wherein the one or more instructions command identification of one or more video frames per shot or per scene of the media content.

4. The system of claim 2, wherein the one or more instructions are received via the GUI, and wherein the one or more instructions command identification of one or more video frames per specified timecode interval of the media content.

5. The system of claim 2, wherein the hardware processor is further configured to execute the AI-based content immersion environment generator to:
output, via the GUI to the user, the one or more 3-D content immersion environments.

6. The system of claim 1, wherein identifying the one or more video frames of the plurality of video frames for use in generating the content immersion environment is performed using metadata included with the media content.

7. The system of claim 1, wherein to generate the 3-D content immersion environment corresponding respectively to each of the one or more video frames, the hardware processor is further configured to execute the AI-based content immersion environment generator to:
determine whether any of the one or more video frames contains an image segment depicting a human, humanoid, or animal; and
inpaint the image segment, when determining determines that the one or more video frames contains the image segment, thereby obscuring the human, humanoid, or animal to provide one or more inpainted video frames;
wherein generating a 3-D content immersion environment corresponding to an inpainted video frame uses the inpainted video frame.

8. The system of claim 1, wherein the hardware processor is further configured to execute the AI-based content immersion environment generator to:
identify, using an AI-based visual analyzer of the AI-based content immersion environment generator, one or more interaction-suitable features depicted in at least one of the one or more video frames;
wherein a 3-D content immersion environment corresponding to the at least one of the one or more video frames includes at least one interactive environmental feature corresponding to at least one of the identified one or more interaction-suitable features.

9. The system of claim 1, wherein the hardware processor is further configured to execute the AI-based content immersion environment generator to:
merge the media content with the one or more 3-D content immersion environments to provide an enhanced media content configured for rendering on a display of a user system.

10. The system of claim 9, wherein the user system comprises a virtual reality (VR) device.

11. A method for use by a system including a computing platform having a hardware processor and a system memory storing an artificial intelligence based (AI-based) content immersion environment generator, the method comprising:
receiving media content, by the AI-based content immersion environment generator executed by the hardware processor, the media content including a plurality of video frames;
identifying, by the AI-based content immersion environment generator executed by the hardware processor, one or more video frames of the plurality of video frames for use in generating a content immersion environment for a display of the media content;
analyzing, by the AI-based content immersion environment generator executed by the hardware processor, foreground, features of each of the one or more video frames to provide one or more respective depth maps of the one or more video frames; and
generating, based on the one or more video frames, by the AI-based content immersion environment generator executed by the hardware processor using a trained AI model of the AI-based content immersion environment generator and the one or more respective depth maps, a three-dimensional (3-D) content immersion environment corresponding respectively to each of the one or more video frames to provide one or more 3-D content immersion environments for the display of the media content.

12. The method of claim 11, wherein the AI-based content immersion environment generator includes a graphical user interface (GUI), and wherein before identification of the one or more video frames is performed, the method further comprises:
receiving via the GUI from a user of the system, by the AI-based content immersion environment generator executed by the hardware processor, data identifying the one or more video frames or one or more instructions for use when identifying the one or more video frames.

13. The method of claim 12, wherein the one or more instructions are received via the GUI, and wherein the one or more instructions command identification of one or more video frames per shot or per scene of the media content.

14. The method for claim 12, wherein the one or more instructions are received via the GUI, and wherein the one or more instructions command identification of one or more video frames per specified timecode interval of the media content.

15. The method of claim 12, further comprising:
outputting via the GUI to the user, by the AI-based content immersion environment generator executed by the hardware processor, the one or more 3-D content immersion environments.

16. The method of claim 11, wherein identifying the one or more video frames of the plurality of video frames for use in generating the content immersion environment is performed using metadata included with the media content.

17. The method of claim 11, wherein to generate the 3-D content immersion environment corresponding respectively to each of the one or more video frames, the method further comprises:
determining, by the AI-based content immersion environment generator executed by the hardware processor, whether any of the one or more video frames contains an image segment depicting a human, humanoid, or animal; and
inpainting the image segment, by the AI-based content immersion environment generator executed by the hardware processor when determining determines that the one or more vide frames contains the image segment, thereby obscuring the human, humanoid, or animal to provide one or more inpainted video frames;
wherein generating a 3-D content immersion environment corresponding to an inpainted video frame uses the inpainted video frame.

18. The method of claim 11, further comprising:
identifying, by the AI-based content immersion environment generator executed by the hardware processor and using an AI-based visual analyzer of the AI-based content immersion environment generator, one or more interaction-suitable features depicted in at least one of the one or more video frames;
wherein a 3-D content immersion environment corresponding to the at least one of the one or more video frames includes at least one interactive environmental feature corresponding to at least one of the identified one or more interaction-suitable features.

19. The method of claim 11, further comprising:
merging, by the AI-based content immersion environment generator executed by the hardware processor, the media content with the one or more 3-D content immersion environments to provide an enhanced media content configured for rendering on a display of a user system.

20. The method of claim 19, wherein the user system comprises a virtual reality (VR) device.
